(19) United States
(12) Patent Application Publication
(10) Pub. No.: US 2004/0212199 A1
(43) Pub. Date: Oct. 28, 2004

(54) Tubular door lock with adjustable backset

(75) Inventor: Lan-Shi Huang, Kaohsiung (TW)

Correspondence Address: BACON & THOMAS, PLLC, 625 SLATERS LANE, FOURTH FLOOR, ALEXANDRIA, VA, 22314

(73) Assignee: Taiwan Fu Hsing Industrial Co., Ltd, Kaohsiung Hsien (TW)

(21) Appl. No.: 10/420,816

(22) Filed: Apr. 23, 2003

(51) Int. Cl. E05B 9/00

(52) U.S. Cl. 292/337

(57) ABSTRACT

A tubular door lock includes a lock case and a latch bolt mounted to an end of the lock case. The latch bolt is connected to a pulling plate that has at least one first protrusion and at least one second protrusion. Two assembling plates are securely mounted to the other end of the lock case. A wheel includes a body pivotally held in a hole of a support plate mounted between the assembling plates. A connecting plate includes at least one tooth for selectively engaging with one of the first protrusion and the second protrusion of the pulling plate. The connecting plate includes an oblong hole through which the body of the wheel extends. The connecting plate further includes at least one guide piece, with a side of an arcuate protruded portion of the body of the wheel abutting against the guide piece.

### BACKGROUND OF THE INVENTION

1. Field of the Invention

The present invention relates to a tubular door lock with adjustable backset. In particular, the present invention relates to a backset-adjustable tubular door lock that has a simplified structure and that can be easily adjusted.

2. Description of Related Art

Tubular door locks with adjustable backset have been proposed. U.S. Pat. No. 4,890,871 discloses a conventional tubular door lock that allows adjustment in the backset. As illustrated in FIG. 8 of the drawings which corresponds to FIG. 1 of U.S. Pat. No. 4,890,871, the tubular door lock includes a lock case 10 for receiving two pulling plates 11 that are connected to a latch bolt 12, each pulling plate 11 having two protrusions 111 and 112. Two assembling plates 13 are mounted to an inner end of the lock case 10 and enclose the pulling plates 11 as well as a wheel 15 consisting of two halves and having two teeth 151. The assembling plates 13 are housed by a movable shell 14 having a hole 141 for pivotally receiving the wheel 15. The moving shell 14 can be moved along a longitudinal direction relative to the lock case 10, thereby adjusting the backset. When the wheel 15 is turned, one of the teeth 151 of the wheel 15 is engaged with one of the protrusions 111 and 112 of an associated pulling plate 11, thereby retracting the latch bolt 12.

U.S. Pat. No. 5,354,109 discloses another conventional tubular door lock that allows adjustment in the backset. As illustrated in FIG. 9 of the drawings which corresponds to FIG. 1 of U.S. Pat. No. 5,354,109, the tubular door lock includes a lock case 20 for receiving two pulling plates 21 that are connected to a latch bolt 22, each pulling plate 21 having two protrusions 211 and 212. Two assembling plates 23 are mounted to an inner end of the lock case 20 and enclose the pulling plates 21 as well as a wheel 24 having two teeth 241. Each assembling plate 23 has an oblong hole 231 along which the wheel 24 moves. Thus, the wheel 24 can be moved along a longitudinal direction relative to the lock case 10, thereby adjusting the backset. A resilient member 25 retains the wheel 24 in place yet allows rotational movement of the wheel 24. When the wheel 24 is turned, one of the teeth 241 of the wheel 24 is engaged with one of the protrusions 211 and 212 of an associated pulling plate 21, thereby retracting the latch bolt 22.

Taiwan Utility Model Publication No. 377743 discloses a further conventional tubular door lock that allows adjustment in the backset. As illustrated in FIG. 10 of the drawings showing the structure of the tubular door lock disclosed in Taiwan Utility Model Publication No. 377743, the tubular door lock includes a lock case 30 for receiving two pulling plates 31 that are connected to a latch bolt 32, each pulling plate 31 having two protrusions 311 and 312. Two assembling plates 33 are mounted to an inner end of the lock case 30 and enclose the pulling plates 31 as well as a wheel 34 consisting of two halves and having two teeth 341. The assembling plates 33 are housed by a movable shell 36. Each assembling plate 33 has an oblong hole 331 along which the wheel 34 moves. Thus, the wheel 34 can be moved along a longitudinal direction relative to the lock case 30, thereby adjusting the backset. A resilient plate 35 retains the wheel 34 in place yet allows rotational movement of the wheel 34. When the wheel 34 is turned, one of the teeth 341 of the wheel 34 is engaged with one of the protrusions 311 and 312 of an associated pulling plate 31, thereby retracting the latch bolt 32.

However, in these conventional tubular door locks, when one of the teeth 151, 241, 341 moves an associated protrusion, e.g., 111, 211, 311, interference with the tooth 151, 241, 341 from the other protrusion 112, 212, 312 should be considered. To avoid this interference, the tooth 151, 241, 341 of the wheel 15, 24, 34 is designed to be longer, yet this causes a greater resistance to rotational movement of the wheel 15, 24, 34.

### OBJECT OF THE INVENTION

The object of the present invention is to provide a tubular door lock with adjustable backset, wherein the structure of the tubular door lock is simplified and wherein the rotational resistance to the wheel of the tubular door lock is reduced, allowing easy, rapid adjustment of the backset.

### SUMMARY OF THE INVENTION

To achieve the aforementioned object, the present invention provides a tubular door lock including a lock case, two assembling plates, a support plate, a wheel, and a connecting plate. A latch bolt is mounted to a first end of the lock case and movable between an extended position outside of the lock case and a retracted position inside the lock case. The latch bolt is connected to a pulling plate having an end extending out of a second end of the lock case. The end of the pulling plate has at least one first protrusion and at least one second protrusion.

The assembling plates are securely mounted to the second end of the lock case. Each assembling plate includes at least one positioning hole that allows fixing of the assembling plates and the lock case. Each assembling plate further includes an oblong hole.

The support plate is mounted between the assembling plates and includes at least one positioning hole aligning with the positioning hole of each assembling plate. The support plate further includes a hole. The wheel includes a body pivotally held in the hole of the support plate. The body of the wheel is slidable along the oblong holes of the assembling plates. An arcuate protruded portion projects outward from an outer periphery of the body of the wheel.

The connecting plate includes at least one tooth on an end thereof for selectively engaging with one of the first protrusion and the second protrusion of the pulling plate. The connecting plate includes an oblong hole through which the body of the wheel extends. The connecting plate further includes at least one guide piece, with a side of the arcuate protruded portion of the wheel abutting against the guide piece.

In an embodiment of the invention, a resilient plate is mounted between the connecting plate and one of the assembling plates. The resilient plate is pressible to cause the tooth of the connecting plate to disengage from the first protrusion and the second protrusion of the pulling plate, allowing movement of the wheel in the oblong holes of the assembling plates for adjusting backset. The resilient plate returns the connecting plate to its original position when the resilient plate is released, thereby causing the tooth of the connecting plate to engage with one of the first protrusion and the second protrusion of the pulling plate.

Other objects, advantages and novel features of this invention will become more apparent from the following detailed description when taken in conjunction with the accompanying drawings.

### BRIEF DESCRIPTION OF THE DRAWINGS

FIG. 1 is an exploded perspective view of a tubular door lock with adjustable backset in accordance with the present invention;

FIG. 2 is a side view, partly sectioned, of the tubular door lock with adjustable backset in accordance with the present invention;

FIG. 3 is a sectional view taken along line A-A in FIG. 2;

FIG. 4 is a view similar to FIG. 3, illustrating retraction of a latch bolt;

FIG. 5 is a view similar to FIG. 2, illustrating a first step of adjustment of the backset;

FIG. 6 is a view similar to FIG. 5, illustrating a second step of adjustment of the backset;

FIG. 7 is a sectional view taken along line B-B in FIG. 6;

FIG. 8 is an exploded perspective view of a conventional tubular door lock with adjustable backset;

FIG. 9 is an exploded perspective view of another conventional tubular door lock with adjustable backset; and

FIG. 10 is an exploded perspective view of a further conventional tubular door lock with adjustable backset.

### DETAILED DESCRIPTION OF THE PREFERRED EMBODIMENT

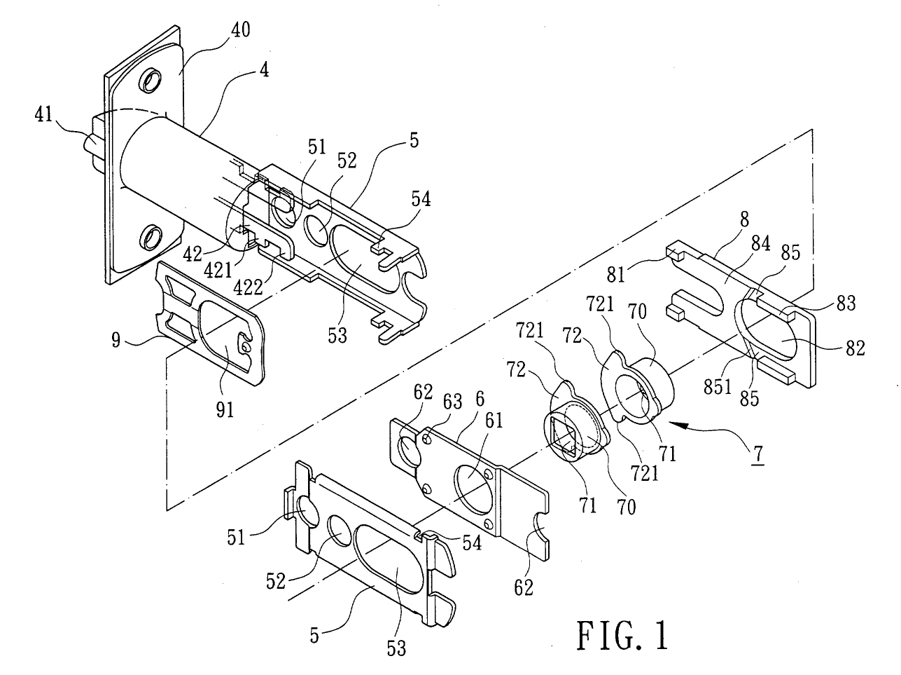

Referring to FIGS. 1 through 3, a tubular door lock with adjustable backset in accordance with the present invention includes a lock case 4, two assembling plates 5, a support plate 6, a wheel 7, a connecting plate 8, and a resilient plate 9.

A faceplate 40 is mounted to an end of the lock case 4. The faceplate 40 and the lock case 4 include holes (not labeled), allowing a latch bolt 41 to move between an extended position outside the lock case 4 and a retracted position inside the lock case 4. The latch bolt 41 is connected to two pulling plate 42 each of which has an end extending beyond the other end of the lock case 4. Each pulling plate 42 has a first protrusion 421 and a second protrusion 422 on the end thereof. When the pulling plates 42 are pulled in a direction away from the lock case 4, the latch bolt 41 is retracted into the lock case 4. When the pulling force is released, the latch bolt 41 returns to the extended position under the action of a return spring (not shown).

The assembling plates 5 are mounted to the other end of the lock case 4. Each assembling plate 5 includes a first positioning hole 51, a second positioning hole 52, and an oblong hole 53. Engaging posts (not shown) are extended through the positioning holes 51 and 52 to thereby fix the assembling plates 5 and the lock case 4 in place. The wheel 7 is movably mounted in the oblong holes 53, which will be described later. The assembling plates 5 include engaging portions 54, allowing secure engagement therebetween.

The support plate 6 is mounted between the assembling plates 5 and in intimate contact with an inner side of one of the assembling plates 5. The support plate 6 includes a hole 61 and two positioning holes 62 respectively on both sides of the hole 61, with the above-mentioned engaging posts respectively extending through the positioning holes 62. The hole 61 of the support plate 6 pivotally holds the wheel 7. In order to reduce the friction between the support plate 6 and the associated assembling plate 5 to which the support plate 6 abuts, the support plate 6 includes a plurality of protuberances 63 that are in contact with the inner side of the associated assembling plate 5.

The wheel 7 includes a body 70 that is pivotally held in the hole 61 of the support plate 6. In this embodiment, the wheel 7 consists of two halves for independent operation with a respective spindle (i.e., inner spindle and outer spindle), with the body 70 of one of the halves being pivotally held in the hole 61 of the support plate 6. Each half of the wheel 7 includes a non-circular hole 71 through which an associated one of the inner spindle and the outer spindle extends. Thus, when either spindle is turned, the associated half of the wheel 7 is turned. Further, each half of the wheel 7 has an arcuate protruded portion 72 projecting outward from an outer periphery of the body 70 thereof.

The connecting plate 8 is mounted between the assembling plates 5 and includes two teeth 81 for engaging with the first protrusions 421 or the second protrusions 422 of the pulling plates 42. The connecting plate 8 further includes an oblong hole 82 through which the body 70 of the other half of the wheel 7 extends. Further, the connecting plate 8 includes two guide pieces 83 against which two sides 721 of the arcuate protruded portion 72 of the other half of the wheel 7 respectively abut. Thus, when the wheel 7 is turned (either clockwise or counterclockwise), the connecting plate 8 is moved away from the lock case 4, with the teeth 81 of the connecting plate 8 engaging with and pulling the first protrusions 421 or the second protrusions 421 of the respective pulling plate 42, thereby retracting the latch bolt 41 into the lock case 4. A side (the inner one in FIG. 1) of the connecting plate 8 in contact with the arcuate protruded portion 72 of the associated half of the wheel 7 includes a first planar face 84, a second planar face 85, and a slant face 851 between the first planar face 84 and the second planar face 85. An outer periphery of the arcuate protruded portion 82 is located in a join area of the second planar face 85 and the slant face 851.

In order to provide reliable engagement between the respective teeth 81 of the connecting plate 8 and the first protrusions 421 or the second protrusions 421 of the pulling plates 42, the resilient plate 9 is mounted between the connecting plate 8 and an associated one of the assembling plates 5. The resilient plate 5 is so slightly bent that the resilient plate 5 can be pressed to a flattened state and that the resilient plate 5 restores its original shape after the pressing force is released. The resilient plate 9 includes a hole 91 through which the body 70 of an associated half of the wheel 7 extends.

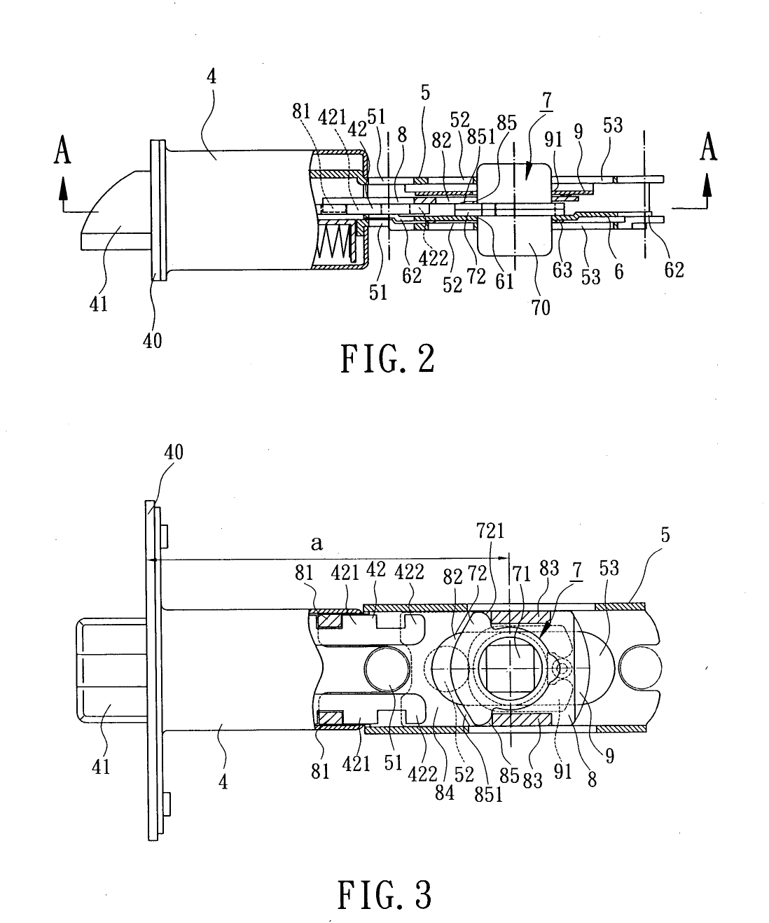

FIGS. 2 and 3 illustrates the tubular door lock after assembly. When the tubular door lock has a smaller backset “a”, the teeth 81 of the connecting plate 8 are respectively engaged with the first protrusions 421 of the pulling plates 42. The connecting plate 8 is biased by the resilient plate 9 so that the teeth 81 are reliably engaged with the first protrusions 421. The two sides 721 of the arcuate protruded portion 721 of one of the halves of the wheel 7 respectively abut against the guide pieces 83 of the connecting plate 8.

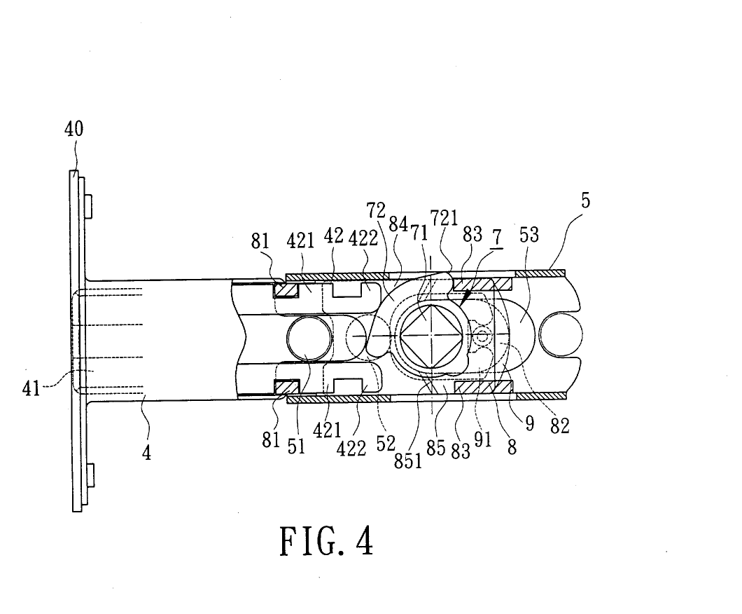

Referring to FIG. 4, when one of the inner spindle and the outer spindle of the tubular door lock turns and thus causes rotation of the wheel 7, the arcuate protruded portion 72 of one of the halves of the wheel 7 presses against the associated guide piece 83, moving the connecting plate 8 away from the lock case 4. The teeth 81 of the connecting plate 8 pull the pulling plate 42 away from the lock case 4, thereby retracting the latch bolt 41 into the lock case 4. The outer periphery of the arcuate protruded portion 72 of the associated half of the wheel 7 slides across the slant face 851 when the wheel 7 is turned by either spindle of the tubular door lock. Thus, the wheel 7 does not interfere with movement of the connecting plate 8.

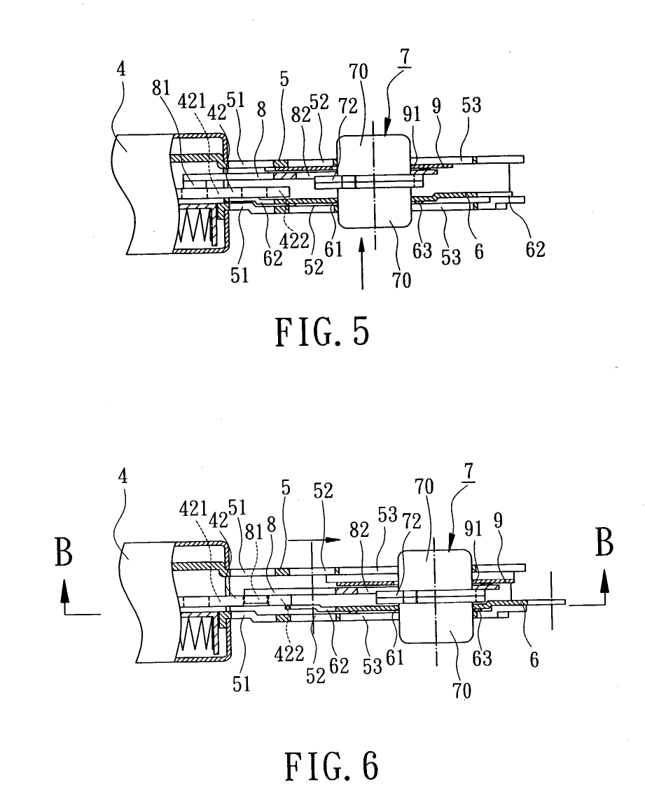

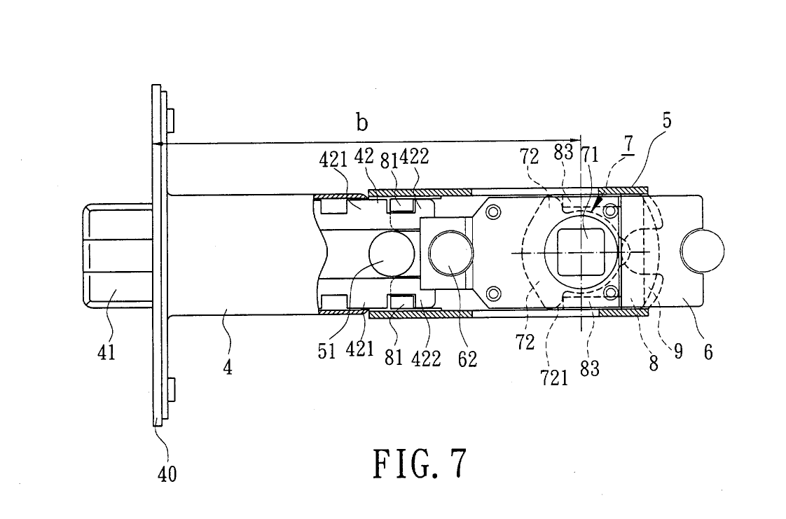

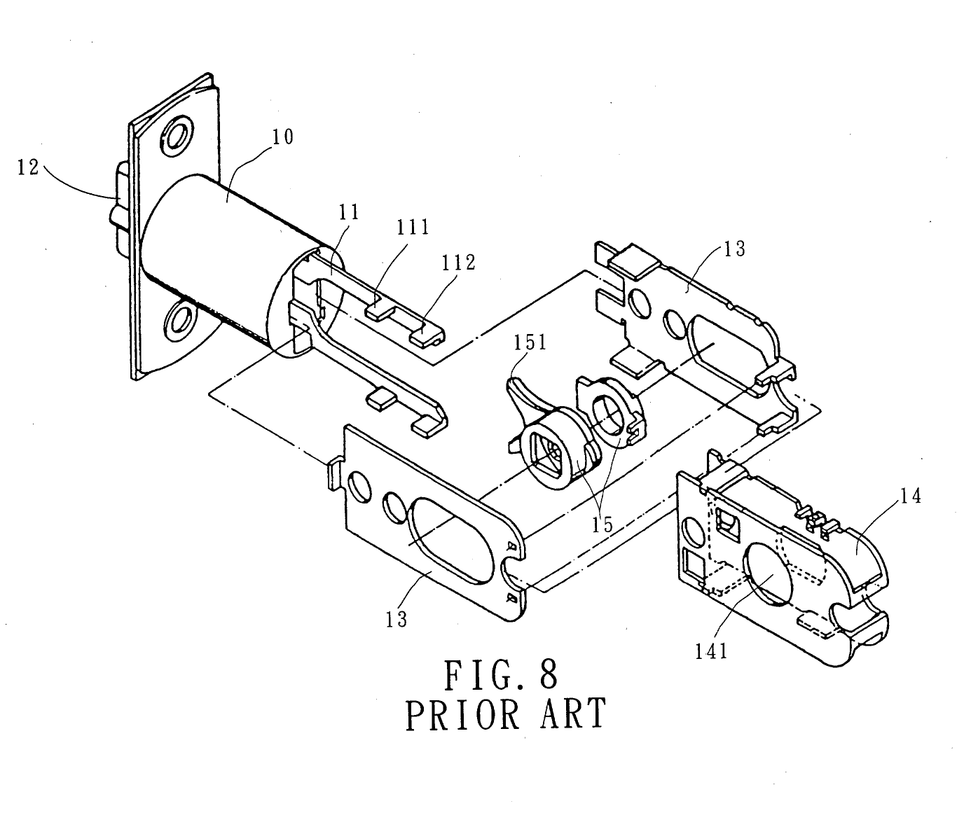

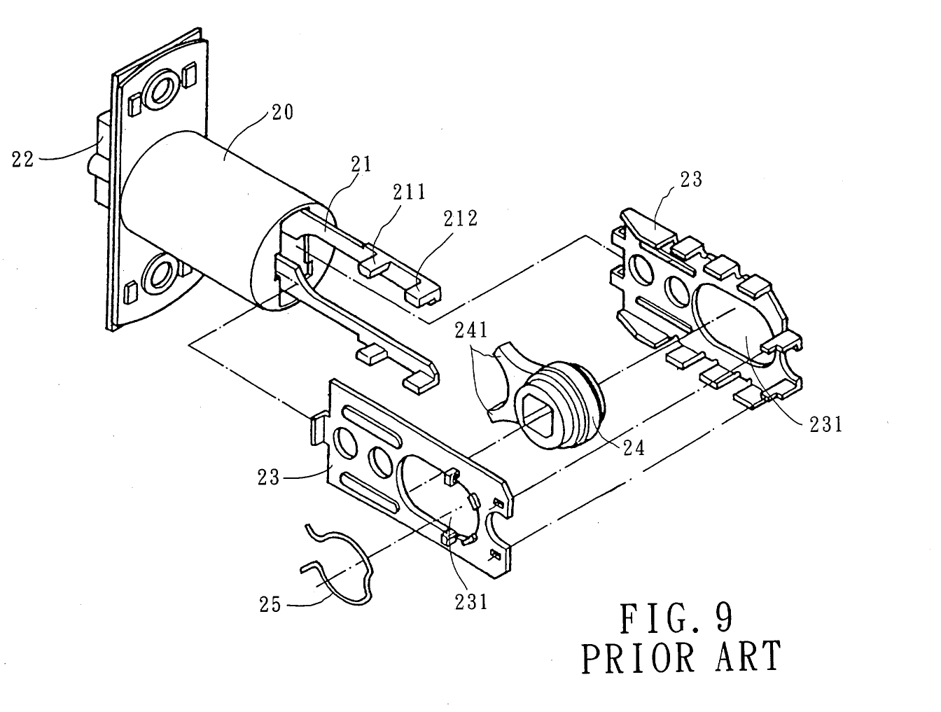

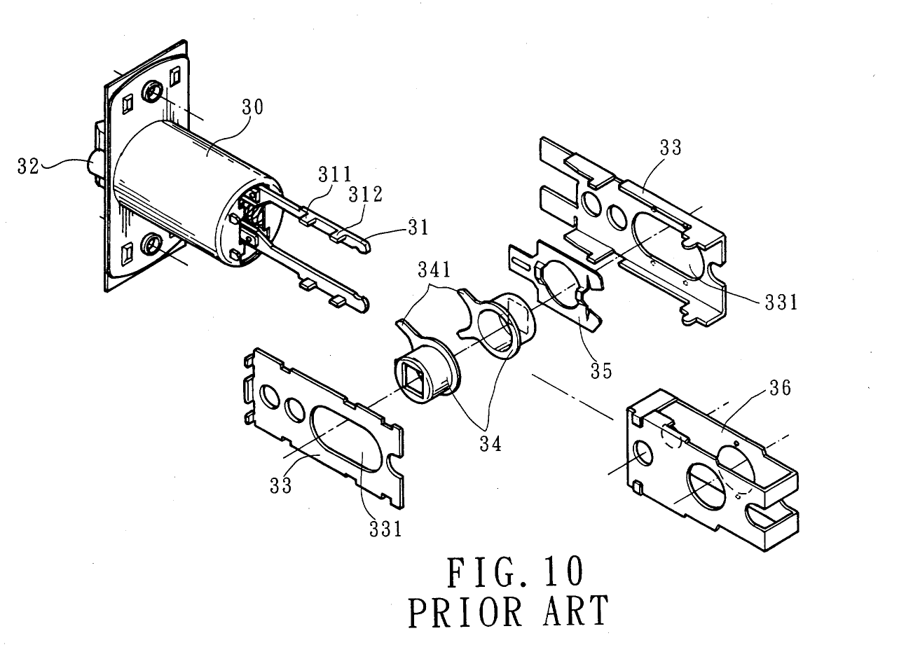

Referring to FIG. 5, when adjustment of the backset is required, the wheel 7 is pressed along the arrow shown in FIG. 5 until the protruded arcuate portion 72 of the associated half of the wheel 7 is in intimate contact with the second planar face 85. The connecting plate 8 is simultaneously pressed to disengage the teeth 81 of the connecting plate 8 from the first protrusions 421, as shown in FIG. 6. Then, the wheel 7 is moved away from the lock case 4 until the teeth 81 of the connecting plate 8 reach a position correspond to that of the second protrusions 422 of the pulling plates 42. The pressing force to the wheel 7 is then released, and the wheel 7 returns to its original position under the action of the resilient plate 9. The teeth 81 of the connecting plate 8 return to their original position and thus engage with the second protrusions 422 of the pulling plates 42, as shown in FIG. 7. The backset of the tubular door lock is adjusted to a longer one (see backset “b” in FIG. 7).

It is apparently clear from the forgoing description that the tubular door lock in accordance with the present invention allows easy, rapid adjustment and has a simplified structure through the use of the guide pieces 83 of the connecting plate 8. Further, the arcuate protruded portion 72 of the wheel 7 avoids interference with the operation of the tubular door lock. Thus, the contact point between the arcuate protruded portion 72 and the guide pieces 83 is close to a center of the wheel 7, thereby having a relatively smaller rotational resistance to the wheel 7.

The pulling plates 42 may be integrally formed or connected together at inner ends thereof. In a simplified embodiment of the invention, only one pulling plate 42 is used, and the connecting plate 8 includes only one tooth 81.

While the principles of this invention have been disclosed in connection with its specific embodiment, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A tubular door lock, comprising:
a lock case including a first end and a second end, a latch bolt being mounted to the first end of the lock case and movable between an extended position outside of the lock case and a retracted position inside the lock case, the latch bolt being connected to a pulling plate having an end extending out of the second end of the lock case, the end of the pulling plate having at least one first protrusion and at least one second protrusion;
two assembling plates securely mounted to the second end of the lock case, each said assembling plate including at least one positioning hole, allowing fixing of the assembling plates and the lock case, each said assembling plate further including an oblong hole;
a support plate mounted between the assembling plates and including at least one positioning hole aligning with said at least one positioning hole of each said assembling plate, the support plate further including a hole;
a wheel including a body pivotally held in the hole of the support plate, the body of the wheel being slidable along the oblong holes of the assembling plates, an arcuate protruded portion projecting outward from an outer periphery of the body of the wheel; and
a connecting plate including at least one tooth on an end thereof for selectively engaging with one of said at least one first protrusion and said at least one second protrusion of the pulling plate, the connecting plate including an oblong hole through which the body of the wheel extends, the connecting plate further including at least one guide piece, with a side of the arcuate protruded portion of the wheel abutting against said at least one guide piece.

2. The tubular door lock as claimed in claim 1, further including a resilient plate mounted between the connecting plate and one of the assembling plates, the resilient plate being pressible to cause said at least one tooth of the connecting plate to disengage from said at least one first protrusion and said at least one second protrusion of the pulling plate, allowing adjustment of backset, the resilient plate returning the connecting plate to its original position when the resilient plate is released, thereby causing said at least one tooth of the connecting plate to engage with said one of said at least one first protrusion and said at least one second protrusion of the pulling plate.

3. The tubular door lock as claimed in claim 1, wherein the assembling plates include engaging portions, allowing reliable engagement therebetween.

4. The tubular door lock as claimed in claim 1, wherein the support plate includes a plurality of protuberances that are in contact with an inner side of an associated one of the assembling plates.

5. The tubular door lock as claimed in claim 1, wherein the wheel consists of two halves.

6. The tubular door lock as claimed in claim 1, wherein the connecting plate includes two guide pieces, with two sides of the arcuate protruded portion of the wheel respectively abutting against the guide pieces.

7. The tubular door lock as claimed in claim 1, wherein a side of the connecting plate contacting the arcuate protruded portion of the wheel includes a first planar face, a second planar face, and a slant face between the first planar face and the second planar face.
